(19) United States
(12) Patent Application Publication
(10) Pub. No.: US 2007/0259581 A1
(43) Pub. Date: Nov. 8, 2007

(54) Composite material skin having image

(75) Inventor: Heng-Yen Liu, Jhudong Township (TW)

Correspondence Address: TROXELL LAW OFFICE PLLC, SUITE 1404, 5205 LEESBURG PIKE, FALLS CHURCH, VA, 22041, US

(73) Assignee: HOCHENG CORPORATION

(21) Appl. No.: 11/416,145

(22) Filed: May 3, 2006

(51) Int. Cl. B32B 5/02; B32B 9/04; B32B 27/02; B32B 17/02; A47G 35/00

(52) U.S. Cl. 442/59; 442/164; 442/152; 442/153; 442/172; 442/180; 442/179; 442/169; 428/542.2

(57) ABSTRACT

A surface skin for electronical device has an image layer integrated with in as a part of a whole. The skin is to strengthen the structure of the device; or is to enhance the appearance of the device.

### FIELD OF THE INVENTION

The present invention relates to a composite material skin; more particularly, relates to deposing a skin having an image on an electronical device as a part of the structure to enhance the strength or the hand-feel of the device.

### DESCRIPTION OF THE RELATED ARTS

A general mobile communication device obtains its appearance usually from a plastic injection component or a metal component. The surface of the component is usually formed on a fabric by a spraying or a printing, or by pasting a sticker. Some use a carbon fabric obtained through plain weaving or twill weaving to be hardened, by a resin. Yet the textile obtained is simple. If an additional label is required, it is further pasted on the outside. The variation is not much; but is still in lack of uniformity. Besides, the appearance is not esthetic and so the whole feeling is not good. Hence, the prior arts do not fulfill users' requests on actual use.

### SUMMARY OF THE INVENTION

The main purpose of the present invention is to co-weave an image layer with a fabric layer and form into a whole one together with a covering layer, where a skin is so formed with a specific image on the image layer; and, by applying the skin on an electronical device as a part of the structure, the strength or the hand-feel of the device is enhanced.

To achieve the above purpose, the present invention is a composite material skin having an image, comprising a fabric layer obtained through weaving a plurality of fibers; an image layer located on at least a surface of the fabric layer; and a covering layer integrated with the fabric layer to obtain a whole one, where the image layer is deposed on the fabric layer through the co-weaving; the co-weaving includes a knitting, a braiding, a stitching and a plane-fabric weaving; and the image layer has a label, a set of letters or a figure. Accordingly, a novel composite material skin having an image is obtained.

### BRIEF DESCRIPTION OF THE DRAWINGS

The present invention will be better understood from the following detailed descriptions of the preferred embodiments according to the present invention, taken in con junction with the accompanying drawings, in which

FIG. 1A is a perspective view showing the first preferred embodiment according to the present invention;

FIG. 1B is a cross-sectional view along A-A′ line of FIG. 1A;

FIG. 2 is a perspective view showing the second preferred embodiment;

FIG. 3A is another cross-sectional view a long A-A′ line of FIG. 1A

FIG. 3B is a view of an enlargement area of FIG. 3A;

FIG. 4 is a view showing a state of use of the first preferred embodiment;

FIG. 5A is a cross-sectional view of the third preferred embodiment;

FIG. 5B is a view of an enlargement area of FIG. 5A;

FIG. 6A is a cross-sectional view of the fourth preferred embodiment; and

FIG. 6B is a view of an enlargement area of FIG. 6A.

### DESCRIPTION OF THE PREFERRED EMBODIMENTS

The following descriptions of the preferred embodiment are provided to understand the features and the structures of the present invention.

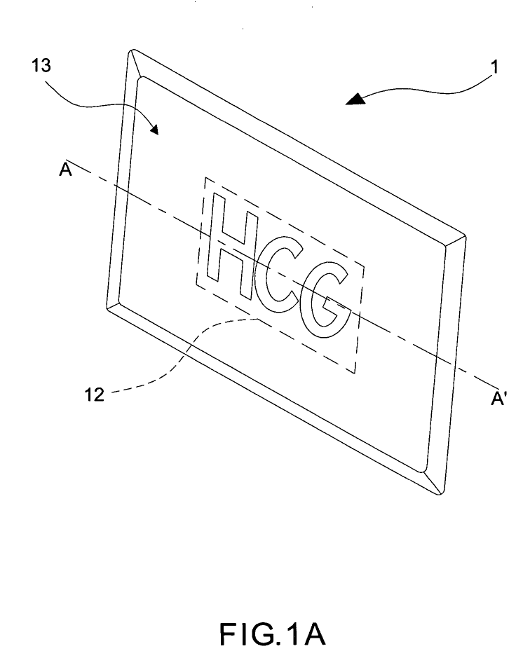

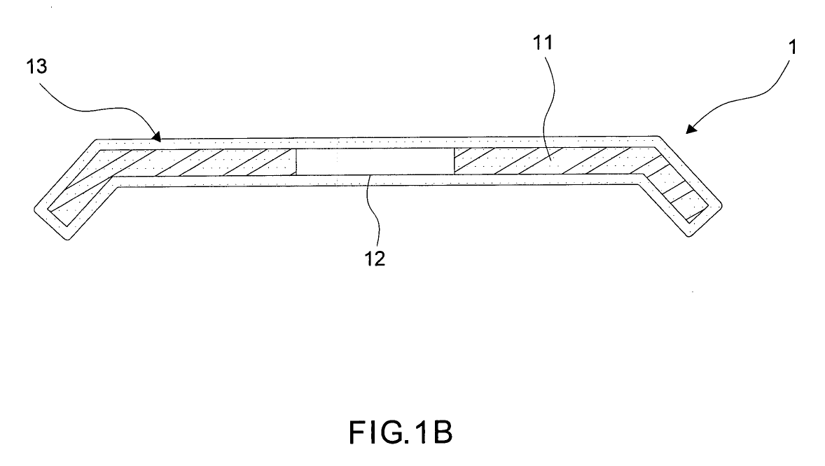

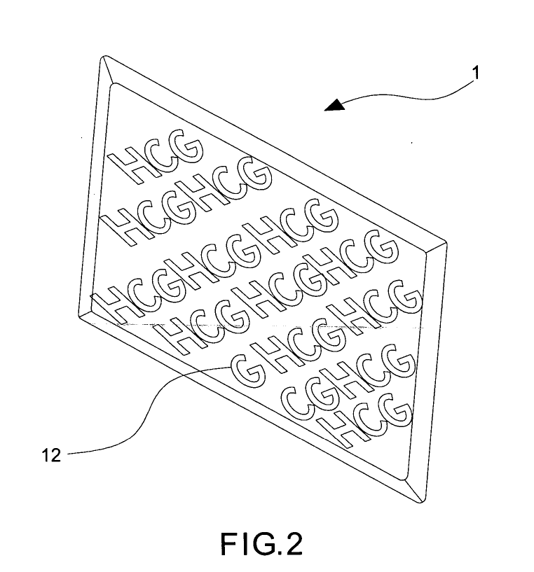

Please refer to FIG. 1A, FIG. 1B and FIG. 2, which are a perspective view showing the first preferred embodiment, a cross-sectional view along A-A′ line of FIG. 1A, and a perspective view showing the second preferred embodiment according to the present invention. As shown in the figures, the present invention is a composite material skin 1 having an image, comprising a fabric layer 11, an image layer 12 and a covering layer 13. The fabric layer 11 is made of a plurality of fibers which are glass fibers, carbon fibers, aramid fibers, cotton fibers or polymer fibers. The fabric layer 11 has an image layer 12 on at least one surface of the fabric layer 11. The image layer is formed on the fabric layer 11 through a co-weaving with the fabric layer 11, or is embroidered on the fabric layer 11, to obtain the skin 1 with the image layer 12 so that, when the fabric layer 11 is fixed on an electronical device, a wholeness is obtained with the structure or the appearance; and further the hand-feel, the integrity or the strength can be enhanced. The co-weaving includes a knitting, a braiding, a stitching and a plane-fabric weaving. The image layer 12 has an image of a single, label, a set of letters or a figure (as shown in FIG. 1B); or a continuous series of the image (as shown in FIG. 2).

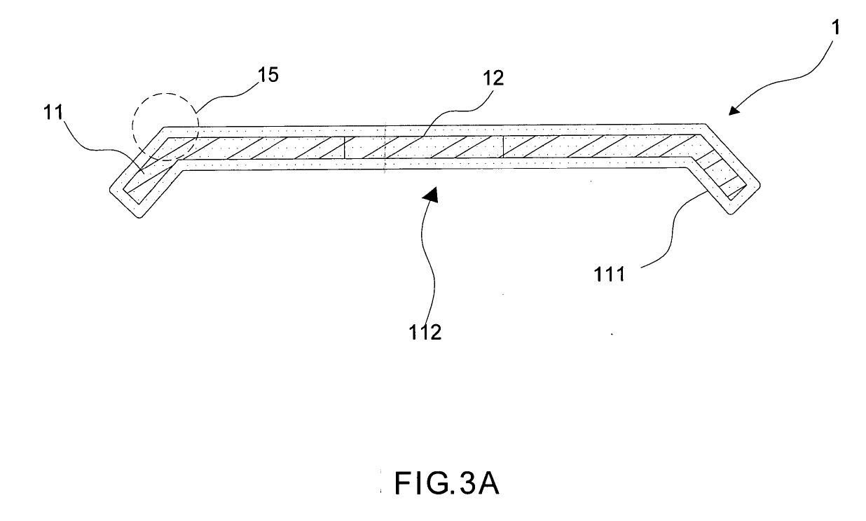

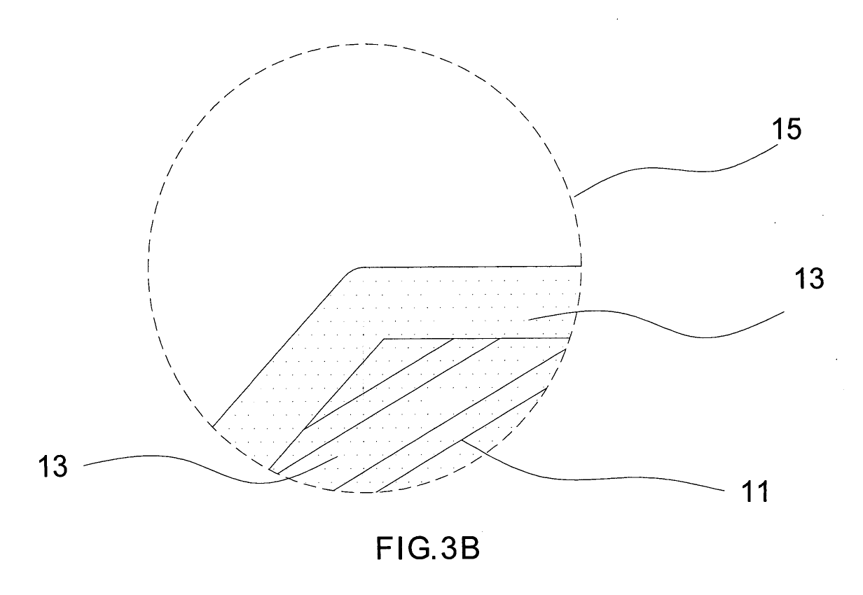

Please further refer to FIG. 3A and FIG. 3B, which are another cross-sectional FIG. 1A and a view of an enlargement area of FIG. 3A. As shown in the figures, according to the shape of an electronical device, a folding side 111 is formed at each side of the fabric layer 11 so that a connecting part 112 is surrounded by the folding sides 111 of the fabric layer 11. As shown in the view of the enlargement area 15 in FIG. 3B, the fabric layer is soaked into or pasted on the covering layer 13 to form a whole one. The covering layer 13 is made of a resin, which is transparent or semitransparent after being hardened; therefore, the resin is a thermosetting resin or a thermoplastic resin. Thus, a novel composite material skin having an image is obtained through hardening the resin with the fabric layer having the image layer deposed upon as a whole one.

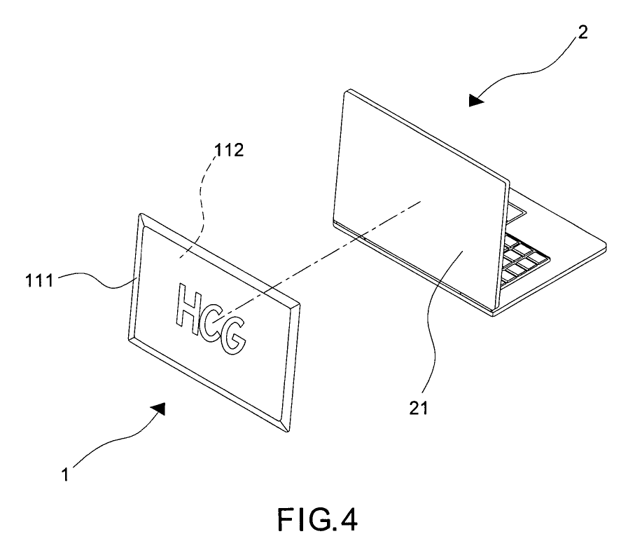

Please refer to FIG. 4, which is a view showing a state of use of the first preferred embodiment. As shown in the figure, when applying a skin 1 of the first preferred embodiment on an electronical device, a notebook 2 here, the skin 1 is corresponding to an outside surface of the display 21 of the notebook 2, where a fabric layer 11 of the skin 1 (as shown in FIG. 3A) is corresponding to the surface of the display 21 with a connecting part 112 of the fabric layer 11. Besides, folding sides 111 of the fabric layer 11 are corresponding to the brims of the display 21; and, the fabric layer 11 of the skin 1 are adhered to the outside surface of the display 21 with an adhesive. Thus, the skin 1 is closely adhered on the outside surface of the display 21; and, an image layer 12 on the fabric layer 11 with a covering layer 13 is so deposed on the outside surface of the notebook 2. In this way, a hand-feel and an appearance of the electronical device are enhanced.

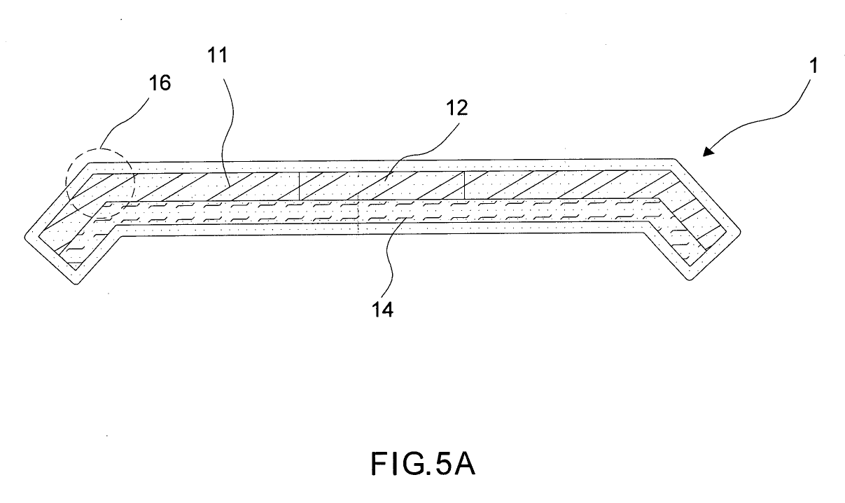

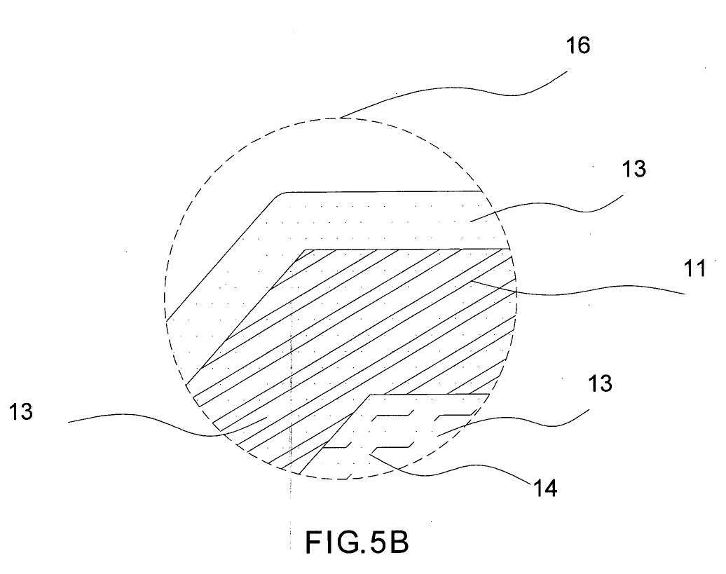

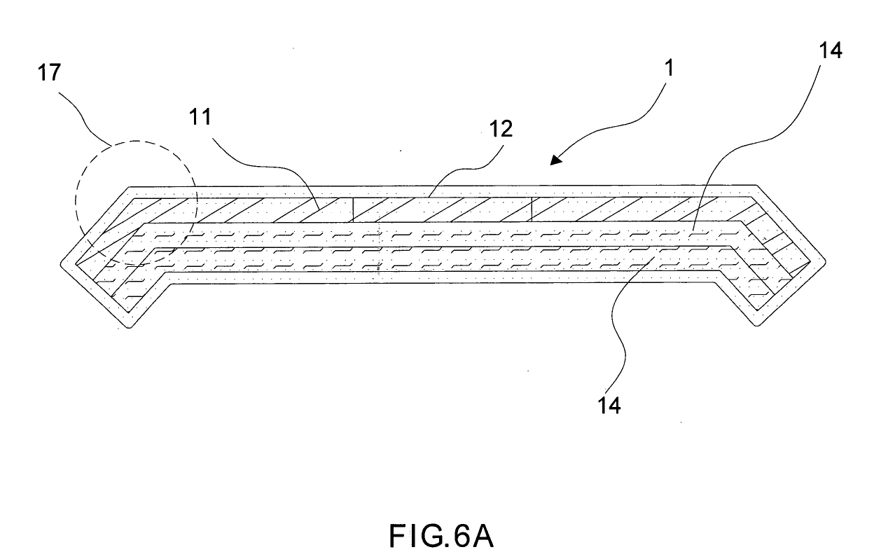

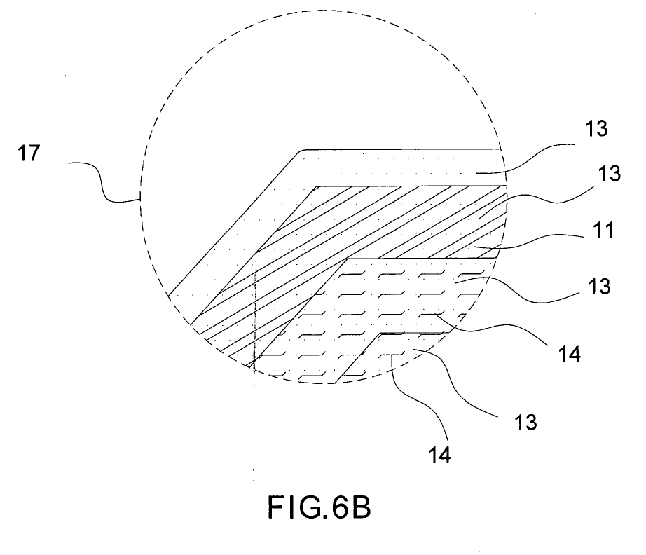

Please refer to FIG. 5A to FIG. 6B, which are a cross-sectional view of the third preferred embodiment, a view of an enlargement area of FIG. 5A, a cross-sectional view of the fourth preferred embodiment, a n d a view of an enlargement area of FIG. 6A. As shown in the figures, at least one fiber layer 14 can be further added on a surface of a fabric layer 11 to increase a thickness of the skin as required. When applying the structure, at least one fiber layer 14 is deposed on a surface of the fabric layer 11. Then the fabric layer 11 together with the fiber layer 14 is soaked into or pasted on a covering layer 13 to form a whole one, as shown in the enlargement areas 16, 17 (FIG. 5B and FIG. 6B). After the covering layer 13 is hardened, a transparent or semitransparent skin with a required thickness is formed. Thus, the present invention can be used on furniture, automobile ornament boards, kitchen equipments and bathroom accessories.

To sum up, the present invention is a composite material skin having an image, where a skin having an image layer with a specific image is obtained when forming a fabric layer; and the skin can be applied to an electronical device as a part of the structure to enhance the strength or the hand-feel of the device.

The preferred embodiments herein disclosed are not intended to unnessarily limit the scope of the invention. Therefore, simple modifications or variations belonging to the equivalent of the scope of the claims and the instructions disclosed herein for a patent are all within the scope of the present invention.

1-8. (canceled)

9. A composite material skin having an image comprising:
a) a fabric layer structure having:
i) a fabric layer having a plurality of woven fibers; and
ii) an image layer integrally formed with the fabric layer and visible on at least one surface of the fabric layer by one of weaving and embroidery; and
b) a covering layer connected to and covering exterior surfaces of the fabric layer and the image layer.

10. The composite material skin according to claim 9, wherein the covering layer is connected to the fabric layer by soaking fabric layer in the covering layer.

11. The composite material skin according to claim 9, wherein the covering layer is connected to the fabric layer by pasting the covering layer to the fabric layer.

12. The composite material skin according to claim 9, wherein the plurality of fibers are selected from a group of fibers consisting of glass fibers, carbon fibers, aramid fibers, and cotton fibers.

13. The composite material skin according to claim 9, wherein the image layer is integrally formed with the fabric layer by a weaving process selected from a group consisting of knitting, braiding, stitching, and plane-fabric weaving.

14. The composite material skin according to claim 9, wherein the covering layer is made of a resin.

15. The composite material skin according to claim 14, wherein the resin is transparent.

16. The composite material skin according to claim 14, wherein the resin is semi-transparent.

17. The composite material skin according to claim 9, wherein the fabric layer structure has at least one fiber layer located on a surface of the fabric layer.

18. The composite material skin according to claim 17, wherein the covering layer connected to and covering exterior surfaces of the fabric layer, the image layer, and the at least one fiber layer.
